(19) United States
(12) Patent Application Publication
(10) Pub. No.: US 2009/0070125 A1
(43) Pub. Date: Mar. 12, 2009

(54) Updating of an electronic periodical

(76) Inventor: Doron Geva, Haifa (IL)

Correspondence Address: AVIA KAFRI, 22 SHDEROT CHEN ST., TEL AVIV, 64166, IL

(21) Appl. No.: 11/896,785

(22) Filed: Sep. 6, 2007

(51) Int. Cl. G06F 17/30; G06F 15/16

(52) U.S. Cl. 705/1; 709/202

(57) ABSTRACT

An electronic periodical includes at least one object its content has at least one updatable segment. Updating is accomplished by substituting a content of a segment of an object stored in a database of objects associated with the currently publicized edition being ready for publishing. Updating rate is higher than the rate in which two successive editions of the periodical are publicized. A subscribing service in which: a. subscribers are eligible to update a selected content of a specified object of a currently publicized edition of the electronic periodical; b. subscribers are notified regarding such intermediate updates, is provided.

### FIELD OF THE INVENTION

The present invention generally relates to electronic periodicals. More specifically, the present invention relates to updating a content of advertisements and/or other objects of electronic periodicals over communications network.

### BACKGROUND OF THE INVENTION

Electronic periodicals, such as daily newspapers accessible in the internet, are common. Visitors to the website of a provider of such periodical are normally displayed with the front page of the periodical's current edition. Reader may publish an object of the periodical typically by pointing and/or clicking. He or she may then store the published object in their computer, print a copy and/or email it to a friend. Often a reader has first to subscribe to a publishing service for publishing any selected edition or some of its content.

In US Patent Application 20020156678A1 a network-based newspaper franchise system and method is disclosed. In accordance with the disclosure a franchisor provides a franchisee a website, a publication engine and hosting service support over a communications network whereby the franchisee can access the franchisor's databases in which objects of international and national news and/or objects of advertisement are stored. The franchisee may incorporate a selection of these objects to his databases containing objects of local news and advertisement such that a subscriber to the service rendered by the franchisee can publish a newspaper by accessing this website in the internet. In US Patent Application 20040240267556A1 an on line news method providing users with free access to a relatively old content whereas content related to currently publicized edition is accessible on paid subscription basis is disclosed.

Normally a magazine of the electronic media mimics the appearance of its traditionally printed version. The electronic version often has the same configuration and organization, includes objects having a similar appearance and may follow the same layout of the pages of the hard-copy. Objects of a magazine generally refer to events including news, articles, opinions, readers' letters, advertisement and the like. The objects of an electronic magazine may also include multimedia pieces such as video, animation, sound and/or audio in addition to the text, graphics and pictures of the traditionally printed media. Quite often the only differences between the electronic and hard-copy editions include an option to expand a segment of an object or in navigating among the various objects. Such expanding or navigating in an electronic version is automatically accomplished, by means of links implanted within the various objects. The entire content of the current addition is prepared in advance and stored in the database of the provider of the periodical prior to the time of its publicizing.

In U.S. Pat. No. 6,460,036 a method for customizing electronic newspaper is disclosed. The disclosed method comprises profiling of the news objects as well as the users' interests and generating users' customized rank ordered listings based on such comparisons between users' interest profiles and the profiles of the objects of news. These rank ordered listings are automatically provided to the respective users such that they may select among the potentially relevant profiled targeted objects.

However common electronic periodicals are updated at their respective routine publicizing rates. Service provider who wishes to advertise and/or provide potential customers with updated data is bounded by the publicizing rates arbitrarily dictated by the providers of the online magazines. Therefore a method providing a reader of an online periodical with currently generated data at a rate which is higher than the respective publicizing rate is beneficial.

### SUMMARY OF THE PRESENT INVENTION

It is an object of the present invention to provide a method for updating an object or a segment of an object of an electronic periodical at a rate that is higher than the rate in which successive editions of the periodical considered are publicized.

It is another object of the present invention to provide an electronic periodical having at least one object a segment of its content is updatable. Such updating is to be accomplished at a rate that is higher than the rate in which successive editions of the periodical considered are publicized.

In accordance with the present invention there is provided a method for updating at least a segment of the content of an object associated with the currently publicized edition of an electronic periodical. Updating is accomplished by substituting a first segment containing the old publicized content with a second segment containing newly updated data in the database in which objects associated with the currently publicized edition, which are ready to be published, are stored. Updating is such accomplished that the updated content is published by accessing the object through communications network immediately following the substituting.

Substituting a segment of the content is accomplished according to the present invention at least once, at any point in time following the moment in which the currently publicized edition was publicized that is prior to the moment in which the successively following edition is publicized. Updating is either scheduled to predefined points in time or accomplished online at any intermediate point in between the publicizing events of two successive editions.

In accordance with the present invention there is provided an electronic periodical having editions successively publicized at a periodical publicizing rate, comprising at least one object a segment of its content is updatable at a rate that is higher than the periodical publicizing rate. The periodical publicizing rate is either fixed along a relatively long period of time or varying in time. Cases in which a segment of an object is updated in between publicizing times of two successive editions are regarded according to the present invention as having a rate that is higher than the periodical publicizing rate. An object a segment of its content is updatable according to the invention is updated at least once in between two points in time in which successive editions of the periodical considered are publicized.

### DETAILED DESCRIPTION OF THE PRESENT INVENTION

In accordance with the present invention an electronic periodical having objects their content is selectively updatable and method for selectively updating a content of an electronic periodical are provided. Substituting an object publicized in one edition of the periodical with a new object to be publicized in the following edition is regarded according to the present invention as updating the object. Objects of a periodical of the present invention are categorized by their updating rates. Among them are objects, which are updated at the same rate in which the editions of the periodical are publicized, as known. Such updating rate is referred hereinafter as the periodical publicizing rate. Periodical publicizing rate which is varying in time is in accordance with the present invention. In such a case any updating which occurs in between two events in which successive editions are publicized is regarded according to the present invention as being accomplished at a rate that is higher than the periodical publicizing rate.

In accordance with the present invention there exists at least one additional category of objects characterized by their updating rate which is higher than the rate in which this periodical is publicized. Exemplary is a monthly journal some of its objects belong to the first category of objects monthly updated (at the periodical publicizing rate). Objects that are retained unchanged for two or more successive editions of the periodical but can be substituted with updated or different objects in one of the coming editions also belong to the first category. Objects that are repeatedly updated at a predefined rate, which is higher than the periodical publicizing rate, respectively belong to other categories. The various categories are characterized by the number of updates of each and every object of the respective category accomplished between two successive times in which a new edition of this periodical is routinely publicized. Synchronizing the publicizing of such intermediate updates is accomplished by the provider of the periodical at predefined points in time along the time interval separating between two successive publicizing times of a new addition of the periodical considered. Namely, a second category exists to which objects updated once between two successive publicizing dates belong. A third category includes objects updated twice within this time interval etc.

A predefined time interval prior to the respective point in time in which an updated object is to be publicized the respective old object, field, or record including the respective segment of this object to be updated, is deleted from the database in which objects associated with the currently publicized edition, to be currently published are stored. The updated object, or the respective updated segment is further stored in this database substituting the one deleted. From this moment on, up to the following point in time in which updating of this object is scheduled, the currently updated object is associated with the currently publicized edition being ready to be published, as known.

The authoring and/or editing of an updated object or an updated segment of an object are accomplished prior to the scheduled time of updating. Updated objects are queued ready for the updating process to start in the coming point in time for updating. Synchronizing and substituting an old object by its respective updated one is automatically accomplished according to a preferred embodiment of the present invention. The operating program for editing an edition of the periodical such that it is ready to be published includes according to the present invention a module for substituting old data with the newly updated data. This module when activated successively handles all the objects waiting in a queue of objects to be updated at the coming point in time for the respective updating. The module either substitutes an entire object with the respective updated object, or substitutes a content of a specified field or a segment of continuously arranged fields within a specified record, stored in the database of objects associated with the currently publicized edition to be currently published. Each object or segment of an object in the queue is associated with respective pointers to the addresses in the memory of the beginning and end of the old and newly updated objects, records or fields and the number of words to be substituted. Deleting is accomplished by writing the new content of each field over the old one. Activation is automatically accomplished by means of a dedicated clock set to measure the time elapsed from the previous updating point in time, as known.

Additional category of objects includes according to the invention objects to be updated online. Online updating of an object of a periodical occurs according to the present invention at least once in between the times in which editions of the periodical are routinely publicized. However following each such update the old object is deleted from the database where objects to be currently published are stored. The currently updated object substitutes the old one and is published by accessing the online periodical through the communications network following a predefined time elapsed from this moment on up to the next updating event in which this very object is being updated again. Online updating is manually accomplished according to a preferred embodiment of the present invention. The operator initiating an online updating process uses a dedicated software tool that is capable for accessing a specified field within a record of the database in which the objects to be currently published are stored. The currently existing content and the newly updated content are displayed to the operator and the substituting of the old content with the newly updated one is accomplished after a manual approval and a confirmation is received from the operator.

Generally an advertiser may publicize an ad the updating rate of is lower than the periodical publicizing rate, as known. He or she may select a segment of the data associated with such ad to be updated at a rate, which is higher than the rate in which the entire ad is updated. In accordance with the present invention such updating rate may exceed the periodical publicizing rate. Routinely and/or online updated advertisement according to the invention may generate a new source of income to the provider of the periodical as it enhances the marketing means available to advertisers.

The segments of data whose updating rate exceeds the periodical publicizing rate need not be according to the present invention directly related to advertisement. For example articles reviewing the state of art considering a technology or line of business are often publicized in periodicals including those having a relatively low publicizing rate, such as quarterly or monthly journals. Such articles might indicate future events related to their subject matter. Exemplary are planed conventions, exhibitions and/or fairs the identities of the participants and/or topics to be presented and/or discussed might get clearer along time following the authoring time of the article. A periodical may better serve its readers by including such updated data regarding such events at a rate which is higher than the periodical publicizing rate. Enhanced updating rate according to the present invention obviously contributes in increasing the number of references made to the article and periodical considered. Readers who are interested in the newly updated data will revisit the periodical for accessing the evolving news. The feature of enhanced publicizing rate may contribute in expanding the circle of readers of a periodical. Furthermore such feature provides for generating additional source of income as service providers who are subscribers to the periodical considered, whose business is related to the subject matter, might be interested in providing the updated data under paid subscription basis, as is further described infra. Readers who are interested in updated information may wish to be noticed that newly updated information is available; therefore an additional subscribing service is provided in accordance with the present invention. Subscribers to this additional service are notified that information related to a specified content of a selected object of the periodical considered has been updated. Such notice includes according to a preferred embodiment of the present invention the identity of the selected object, the specific content lately updated and the time of its last updating. The subscriber is automatically e-mailed by such a message and optionally receives a short messaging service message in addition to the email message by his choice. Such messaging can be also implemented by an automatic phone call in which a pre-recorded message is transmitted, fax transmission and/or recorded voicemail message as known.

### EXAMPLE 1

A retailer wishes to advertise a sale planed to last for a week. The retailer may wish to bring this sale to the public attention some weeks in advance. During each and every day of the sale he or she may want to publicly indicate the product lines to be significantly discounted along say, a few hours, of each day of the sale. The retailer may advertise the sale in any periodical of the present invention including the aforementioned monthly journal. Readers of such monthly journal who wish so, are presented each day prior to the opening of the sale with a daily updated ad containing the same content except for example the number of remaining days to the opening time of the sale. Readers of the journal during each morning of the sale, who wish so, are displayed with the same ad in which a list of product lines to be significantly discounted has been updated at 6am of the same morning. Similarly readers are displayed during the afternoon and later on with the same ad except that the list of discounted products has been updated at noon. Furthermore, according to the present invention in some selected days, readers who wish so are presented with the same ad additionally updated. Such updating has been occurred at a time prior to moment in which the ad is presented, to include the details of a winning customer in a specially discounted product.

Obviously this retailer is able to advertise his planed sale by means of a common daily newspaper and get almost the same results regarding publicizing the updated data following almost the same rate of updating. However such updated advertisement by means of common daily newspaper requires him or her for special planning and managing efforts, such as for providing the various ads at predefined leading times prior to their publication.

### EXAMPLE 2

Bi-weekly periodical of the present invention that is specialized in international shipping normally publicizes routes and schedules of commercial marine transportation lines. Such information is prone to be arbitrarily modified once and/or a few more times between two successive dates in which new editions of the bi-weekly periodical are routinely publicized. Obviously updated content of at least some of the publicized information concerns a potential reader of this periodical. Shipping agencies who are subscribers of the bi-weekly newspaper are offered by the provider of the periodical with an additional service for online updating. Subscriber to the online updating service is allocated with pre-selected segments of such data associated with respective marine transportation lines. The subscriber is further provided with a software package capable for accessing the database of the provider of the periodical and modifying data stored in the respective records related to the selected transportation lines. Accessing the database is accomplished according to a preferred embodiment of the present invention by means of a secured communication line connecting between a subscriber's server and the database in which the objects associated with the currently publicized edition of the periodical ready to be published are stored, as known.

1. A method for updating an object of an electronic periodical having editions publicized at a periodical publicizing rate, wherein said object is published by being accessed by means of communications network, said method comprising substituting at least a segment of the content of said object, which is the first segment, with a second segment including an updated content, wherein said first segment is stored in a database in which objects to be published are stored, and wherein said stored objects are associated with the currently publicized edition, and wherein said substituting accomplished at an intermediate point in time following the time in which said currently publicized edition is publicized.

2. A method as in claim 1, wherein said intermediate point in time is any point in time prior to the publicizing time of the edition successively following said currently publicized edition.

3. A method as in claim 1, wherein said intermediate point in time is predefined.

4. A method as in claim 1, wherein said substituting accomplished at least once prior to the time of publicizing the edition successively following said currently publicized edition.

5. A method as in claim 1, further comprising messaging a subscriber following ay least one of said substituting, wherein said messaging is accomplished by any means selected from a group of messages consisting of phone call, email, fax, short messaging service (SMS), voicemail and any combination thereof.

6. An electronic periodical the objects of are published by being accessed by means of a communications network, having editions publicized at a periodical publicizing rate, said electronic periodical comprising at least one object a segment of its content updatable at a rate higher than said periodical publicizing rate.

7. An electronic periodical as in claim 5, wherein said publicizing is routinely accomplished at a fixed rate.

8. An electronic periodical as in claim 5, wherein said updatable object is updated at least once prior to the publicizing time of the edition successively following the currently publicized edition.
